(19) United States
(12) Patent Application Publication
(10) Pub. No.: US 2025/0274363 A1
(43) Pub. Date: Aug. 28, 2025

(54) INGRESS TRAFFIC SHIFT PREDICTION

(71) Applicant: Microsoft Technology Licensing, LLC, Redmond, WA (US)

(72) Inventors: Borzou ALIPOURFARD, Redmond, WA (US); Elnaz JALILIPOUR ALISHAH, Kirkland, WA (US); Elena A. HELMER, Chapel Hill, NC (US)

(21) Appl. No.: 18/587,170

(22) Filed: Feb. 26, 2024

(51) Int. Cl. H04L 43/062; H04L 41/16; H04L 43/0817

(52) U.S. Cl. CPC H04L 43/062; H04L 41/16; H04L 43/0817

(57) ABSTRACT

A method detects data traffic shifts resulting from ingress link outages of one or more of the ingress links and collects data traffic volumes on the ingress links to the communication network. The data traffic volumes correspond to the detected data traffic shifts. The method receives a query regarding the data traffic shift with respect to the identified ingress link and an identified data packet and generates a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link. Each predicted score is generated by a shift prediction machine learning model trained by the collected data traffic volumes corresponding to the detected data traffic shifts.

### BACKGROUND

Wide-area networks (WANs) are communication networks that tend to span multiple geographical areas and include multiple local-area networks (LANs). For example, an enterprise may manage a WAN across multiple facilities within a city, wherein each facility includes one or more LANs connecting its user devices, server computers, peripherals, etc. The enterprise typically also supports data traffic that flows in (ingress traffic) and out (egress traffic) of the WAN, such as for internal users accessing external computing resources and for external users accessing internal computing resources. In many scenarios, external users may be accessing cloud services provided by computing resources within the WAN, for example.

### SUMMARY

In some aspects, the techniques described herein relate to a method of predicting a data traffic shift responsive to an outage of an identified ingress link to a communication network having ingress links including the identified ingress link and candidate ingress links, the method including: detecting data traffic shifts resulting from ingress link outages of one or more of the ingress links; collecting data traffic volumes on the ingress links to the communication network, the data traffic volumes corresponding to the detected data traffic shifts; receiving a query regarding the data traffic shift with respect to the identified ingress link and an identified data packet; and generating, responsive to the query, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts. In some aspects, the techniques described herein further relate candidate ingress links that are ranked according to the predicted score of each candidate ingress link to yield a ranked list of the candidate ingress links to which the data traffic can shift.

In some aspects, the techniques described herein relate to a computing system for predicting a data traffic shift responsive to an outage of an identified ingress link to a communication network having ingress links including the identified ingress link and candidate ingress links, the computing system including: one or more hardware processors; a data shift detector executable by the one or more hardware processors and configured to detect data traffic shifts resulting from ingress link outages of one or more of the ingress links; a data traffic collector executable by the one or more hardware processors and configured to collect data traffic volumes on the ingress links to the communication network, the data traffic volumes corresponding to the detected data traffic shifts; a shift prediction machine learning model executable by the one or more hardware processors, trained by the collected data traffic volumes, and configured to generate, responsive to a received query regarding the data traffic shift with respect to the identified ingress link and an identified data packet, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by the shift prediction machine learning model trained by the collected data traffic volumes corresponding to the detected data traffic shifts, wherein the candidate ingress links are ranked according to the predicted score of each candidate ingress link to yield a ranked list of the candidate ingress links to which the data traffic can shift.

In some aspects, the techniques described herein relate to one or more tangible processor-readable storage media embodied with instructions for executing on one or more processors and circuits of a computing device a process for predicting a data traffic shift responsive to an outage of an identified ingress link to a communication network having ingress links including the identified ingress link and candidate ingress links, the process including: detecting data traffic shifts resulting from ingress link outages of one or more of the ingress links; collecting data traffic volumes on the ingress links to the communication network, the data traffic volumes corresponding to the detected data traffic shifts; receiving a query regarding the data traffic shift with respect to the identified ingress link and an identified data packet; and generating, responsive to the query and by a ranking support vector machine model, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example communication network having multiple ingress points positioned at its boundary.

FIG. 2 illustrates an example communication network experiencing a data traffic shift among ingress points positioned at its boundary.

FIG. 3 illustrates an example traffic shift predictor.

FIG. 4 illustrates example operations for predicting a data traffic shift responsive to an outage of an identified ingress link to a communication network having ingress links including the identified ingress link and candidate ingress links.

FIG. 5 illustrates an example computing device for use in implementing the described technology.

### DETAILED DESCRIPTIONS

Communication networks can often be described as having network interface points at network boundaries through which data traffic enters and/or leaves the network. Data traffic entering such a network is referred to as “ingress traffic” and is said to enter the network via “ingress links” connected to “ingress points” at the boundary of the communication network. The ingress links to a communication network are sometimes termed “peering links.” In some implementations, an ingress point can also be combined with an “egress point” through which “egress traffic” leaves the network via an “egress link.” When one of the links becomes inoperable, it is described as a “peering link outage” or an “ingress link outage.”

The described technology uses a machine learning model to predict how ingress traffic will shift throughout the network if one or more ingress points become inoperable (e.g., are taken down for maintenance, experience a failure, lose connection to the WAN or other WANs). Such a prediction provides a technical benefit of identifying other ingress points, network connections, and computing resources of the network that may experience an increase in ingress traffic and facilitate network management to mitigate network performance degradation resulting from the ingress traffic shift. For example, the prediction can be used by network management systems and/or the enterprise's network engineers to repurpose or reconfigure other network and computing resources, redirect other traffic, etc. In summary, the described technology provides a probabilistic machine learning tool to predict the shifts in the ingress data traffic to a communications network following one or more peering link outages.

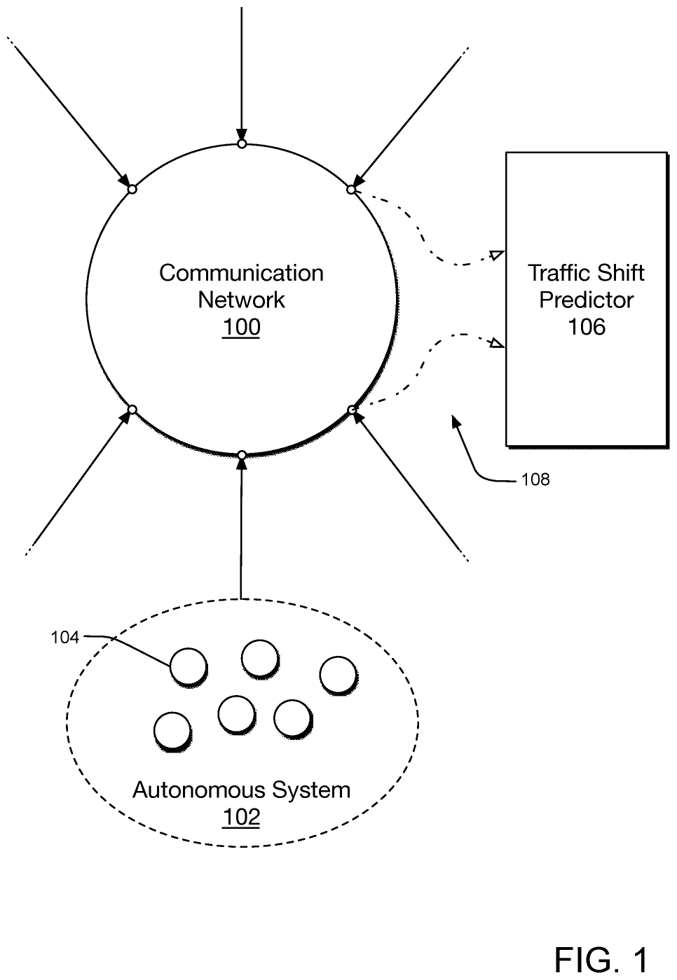

FIG. 1 illustrates an example communication network 100 having multiple ingress points positioned at its boundary. For purposes of this description, the ingress points are represented as circles on the boundary of the communication network 100, and each ingress point is connected to an ingress link (represented as arrowed lines), each ingress link at least being configured to communicate data traffic into the communication network 100 through the corresponding ingress point. In some implementations, an ingress link may also operate as an egress link configured to communicate data traffic out of the communication network 100.

Each ingress link to the communication network 100 may be connected to one or more autonomous systems, such as autonomous system 102. An autonomous system (AS) includes a collection of connected Internet Protocol (IP) prefixes (see, e.g., IP prefix 104) under the control of one or more network operators on behalf of an administrative entity or domain. An autonomous system generally presents a defined routing policy to the Internet. Each AS is assigned an autonomous system number (ASN) for use in board Gateway Protocol (BGP) routing. One or more IP prefixes can be assigned to a single AS, wherein the IP routing prefix specifies a range of IP addresses. Because of the way IP addresses are formatted, IP address prefixes can be expressed in this fashion: 192.0.2.0/24. This represents IP addresses 192.0.2.0 through 192.0.2.255 and not 192.0.2.0 through 192.0.2.24. In this manner, the communication network 100 may receive data traffic via one or more of its ingress links from multiple source autonomous systems and/or multiple source IP prefixes.

A traffic shift predictor 106 may execute internally or externally with respect to the communication network 100. The traffic shift predictor 106 includes a data traffic collector that collects historical traffic data of the ingress links to the communication network (shown by the dashed arrowed lines 108) relative to detected historical peering link outages and data traffic shifts.

In various implementations, the traffic shift predictor 106 detects data shifts and collects the historical traffic data from all of the ingress links to the communication network 100, although in other implementations, some or all of the historical traffic data may be collected by the traffic shift predictor 106 from other monitoring services or systems. The historical traffic data corresponds to windows of data traffic collected in temporal proximity to detected peering link outages, allowing the traffic shift predictor 106 to capture historical data traffic shifts resulting from historical ingress link outages of one or more of the ingress links. The historical traffic data represents an ingress traffic profile of data traffic flowing into the communication network 100, suggesting the ways in which external systems might react to ingress link outages of the communication network 100.

The traffic shift predictor 106 also includes a communication interface that can send and/or receive communications, including the historical traffic data, queries requesting data traffic shift predictions, and ranked lists of candidate ingress links that may receive shifted data traffic in response to an outage of another ingress link. In response to such a query requesting a data traffic shift prediction, a shift prediction machine learning model of the traffic shift predictor 106 generates a predicted score for each of the candidate ingress links. Each predicted score indicates a likelihood that data traffic corresponding to the identified data packet will shift from the identified ingress link to a corresponding one of the candidate ingress links responsive to the outage of the identified ingress link. In some implementations, the traffic shift predictor 106 also includes a ranker that ranks the candidate ingress links according to the predicted score of each candidate ingress link to yield a ranked list of the candidate ingress links to which the data traffic can shift.

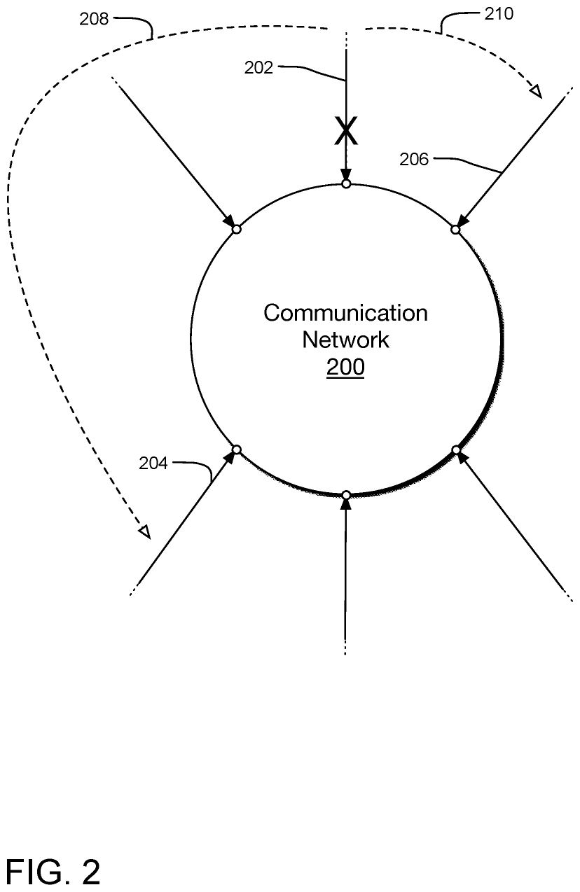

FIG. 2 illustrates an example communication network 200 experiencing a data traffic shift among ingress points positioned at its boundary. For purposes of this description, the ingress points are represented as circles on the boundary of the communication network 200, and each ingress point is connected to an ingress link (represented as arrowed lines), each ingress link at least being configured to communicate data traffic into the communication network 200 through the corresponding ingress point. In some implementations, an ingress link may also operate as an egress link configured to communicate data traffic out of the communication network 200.

In a normal operational state, the volume of data traffic entering the communication network 200 via an ingress link 202 can generally vary with time, communicating lesser or greater volumes of data traffic. Nevertheless, if the ingress link 202 or its corresponding ingress point (e.g., a router) becomes inoperable, impaired, or otherwise unavailable (as indicated by the “X” marked over the ingress link 202), the data traffic that would ordinarily be directed through the ingress link 202 is rerouted by systems outside the communication network 200 in an effort to bypass the faulty ingress link and communicate data traffic into the communication network 200 through one or more different ingress links (e.g., an ingress link 204 and an ingress link 206), as shown by the dashed arrow 208 and dashed arrow 210. When an ingress link becomes inoperable, impaired, or otherwise unavailable, the condition is called an ingress link outage.

As this rerouting is typically controlled by other systems, the network engineers of the communication network 200 generally have little or no influence over which ingress links will be selected for the rerouting as these selections are determined by the external systems. Accordingly, the data traffic previously carried by the faulty ingress link 202 will continue to flow into the communication network 200 through an alternate set of one or more ingress links to the communication network 200, primarily or entirely based on rerouting performed by external systems. In light of the external dependencies of this rerouting, the network engineers of the communication network 200 do not have a deterministic manner in which to identify which of the other ingress links to the communication network 200 will receive this new data traffic or how much new data traffic will shift to any particular ingress link.

The described technology confidently predicts such shifts in the network's ingress traffic, and such predictions can allow network management systems and network engineers (collectively, “network management resources”) of the communication network 200 to manage the communication network 200 in an effort to assure that the other ingress links can handle the predicted change in data traffic. Therefore, these predictions can assist network management resources to better perform failure analyses and safety checks, schedule network maintenance at the other ingress links, mitigate network ingress congestion, and/or guide capacity planning, among other actions. Failure to adequately manage the increased data traffic through each of these ingress links can overload one or more ingress links, which can result in increased latency or even a cascade of link outages, among other problems.

As mentioned previously, the routing of ingress traffic to specific ingress points via specific ingress links is influenced and/or controlled by routing policies, connectivity constraints, traffic engineering strategies, etc. at various external systems, such as autonomous systems, all or most of which are at best case opaque, and worse case confidential or otherwise not available outside those external systems. Nevertheless, while these external influences are generally inaccessible or indecipherable (e.g., collectively “masked”) by the network management of the communication network 200, many of these influences are still somewhat reflected in the ingress traffic profile of the communication network 200 itself. An ingress traffic profile represents an observable window of what is going on outside the communication network 200. Accordingly, the described technology relies on the ingress traffic profile of the communication network 200 to predict where data traffic may shift if its current ingress point is no longer available.

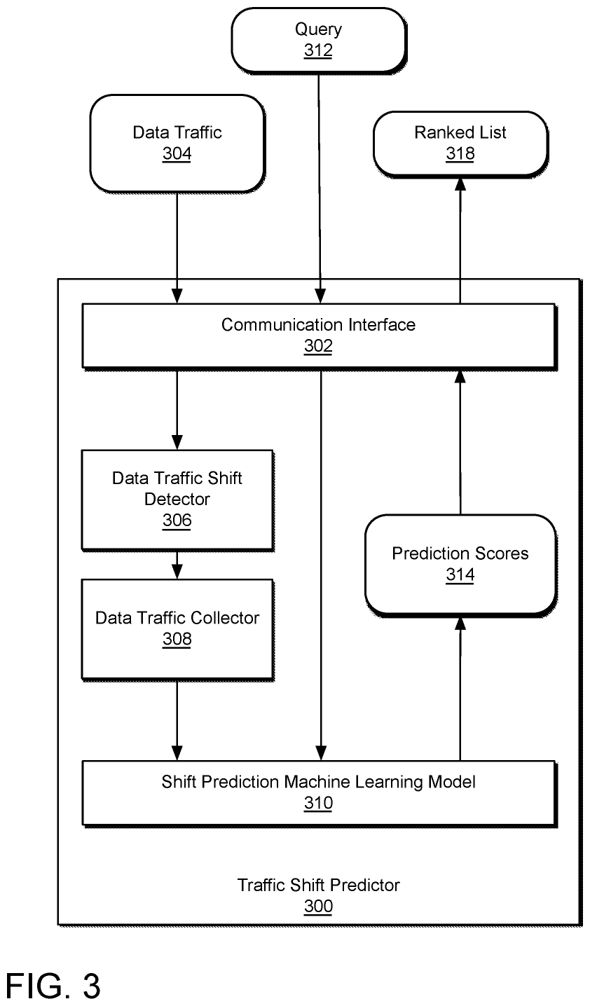

FIG. 3 illustrates an example traffic shift predictor 300. In a process of collecting training data, the traffic shift predictor 300 receives, through a communication interface 302, data traffic 304 entering a communication network via ingress links and ingress points. The data traffic 304 may include the actual data traffic itself (e.g., including communication protocol layers and payloads), summaries of such data traffic, etc. A data traffic shift detector 306 evaluates the data traffic 304 to detect changes in data traffic volume entering via one or more of the ingress links to the communication network. For example, if the data traffic shift detector 306 detects an unexpected decrease in data traffic volume, whether sudden or gradual, entering the communication network via a particular ingress link, the data traffic shift detector 306 may identify that a potential peering link outage has been detected at that ingress link and that a data traffic shift may occur in response to the outage.

Responsive to such a detection of an ingress link outage and/or data traffic shift, a data traffic collector 308 collects data traffic volumes (and related information such as source autonomous system numbers and source internet protocol prefixes) on the ingress links to the communication network, such that the collected data traffic volumes correspond to the detected data traffic shift. It should be understood that the data traffic shift detection and data traffic collection may alternatively be performed by systems outside the traffic shift predictor 300.

Over time, the data traffic collector 308 collects data traffic volumes for the ingress links to the communication networks corresponding to the data traffic shifts resulting from ingress link outages—when a data traffic shift arose responsive to an ingress link outage, to which other ingress links did individual data packets get redirected. The collected data traffic volumes and related information are used as training data (e.g., potentially subject to a ranking transformation described below) to train a shift prediction machine learning model 310 to predict the likely changes in traffic flow into the communication network.

Features of the training data may include, without limitation, one or more of the following:

SrcASNMbps: the volume of the data traffic traversing through the candidate ingress links originating/sourced from a specific external autonomous system and flowing into the communication network

SrcASNFriendsMbps: the volume of the data traffic traversing through the candidate links originating/sourced from a specific external autonomous system and flowing into the communication network and from any specific external autonomous system that had historically sent data traffic through the ingress link experiencing the outage

SrcASN Cosine Similarity: the cosine similarity between the data traffic volume carried by the ingress link experiencing the outage and originating at a specific external autonomous system and the data traffic volume carried by each candidate ingress link originating/sourced from the same external autonomous system within an hour before the outage

SrcPrefixMbps: the volume of the data traffic traversing through the candidate ingress links originating/sourced from a specific external Internet Protocol prefix and flowing into the communication network

SrcPrefixCloseFriendsMbps: the volume of the data traffic traversing through the candidate links originating/sourced from a specific external Internet Protocol prefix and flowing into the communication network and from any other external Internet Protocol prefix that had historically sent data traffic through the same external autonomous system and through the ingress link experiencing the outage

SrcPrefixFriendsMbps: the volume of the data traffic traversing through the candidate links originating/sourced from a specific external autonomous system and flowing into the communication network and from any specific external Internet Protocol prefix that had historically set data traffic through the ingress link experiencing the outage

SrcPrefix Cosine Similarity: the cosine similarity between the data traffic volume carried by the ingress link experiencing the outage and originating/sourced at a specific external Internet Protocol prefix and the data traffic volume carried by each candidate ingress link originating from the same external Internet Protocol prefix within an hour before the outage

GeoDistance: the geographical distance between the ingress link experiencing the outage and each candidate ingress link

ASNOverlap: a Boolean feature designating whether the autonomous systems sending traffic to the ingress link experiencing the outage overlap with the autonomous systems sending traffic to each of the candidate ingress links (e.g., data traffic originating from at least one identical autonomous system)

The shift prediction machine learning model 310 may be trained, using the collected training data, by an internal or external trainer to the traffic shift predictor 300. To train the machine learning model, in some implementations, the training data is transformed into a partially ordered set (poset), where the partial order is the ranking of the different ingress links. In this partial order, the ingress links to which traffic shifted are ranked higher than the ingress links to which the traffic did not shift. These other ingress links, to which traffic does not shift, are not ranked against one another. The shift prediction machine learning model 310 is trained such that the ranking produced by its scores aligns with the rankings in the collected training data. The training of the shift prediction machine learning model 310 may be updated periodically or in response to detected conditions within or without the communications network. At inference/prediction time, the shift prediction machine learning model 310 generates a score in such a way that the ranking produced by the scoring prediction aligns with the ranking provided by the training data.

In one implementation, the shift prediction machine learning model 310 is in the form of a ranking support vector machine (RankSVM), a machine learning model trained to adaptively sort results based on how ‘relevant’ they are for a specific query. In various implementations, the RankSVM machine learning model can use a kernel mapping function projecting the features of each of the possible results onto a higher dimensional kernel space. These kernels can be linear or non-linear. In other implementations, the RankSVM model can use the original features (e.g., as described above). In some implementations, the RankSVM is trained by transforming the original ranking problem into a pairwise classification problem. In this transformation, the raw training data is transformed by taking each pair of training data that is comparable to another (e.g., there is a defined order where one sample is ranked higher or lower than the other) and assigning each pair a label: a pair is given a positive label if the first of the pair is ranked higher than the second. This pairwise training dataset can then be used to train the RankSVM model for assigning a coefficient to each feature so that the ingress links to which data traffic actually shifted have a higher prediction score (sum of all of the coefficients*feature for a given ingress link) than ingress links that did not receive shifted data traffic (the asterisk denotes a multiplication operator). It should, however, be understood that other machine learning models may be employed as the shift prediction machine learning model 310.

Given a trained shift prediction machine learning model 310, the traffic shift predictor 300 may receive a query 312 via the communication interface 302 that identifies an ingress link of the communications network and a data packet. Note: It should be understood that the shift prediction machine learning model 310 has been trained based on data traffic volumes entering the network via the identified ingress link and the other ingress links to the communication network.

Features of the identified data packet, the identified ingress link, and features of each candidate ingress link are input to the shift prediction machine learning model 310, which generates a prediction score (see prediction scores 314) for each candidate ingress link indicating a likelihood that data traffic corresponding to the identified data packet will shift from the identified ingress link to a corresponding one of the candidate ingress links responsive to the outage of the identified ingress link. In one implementation, the features of the historical ingress link outage events are transformed into a partially ordered set (poset), where the partial order is the ranking of the different ingress links. The candidate ingress link to which data traffic shifts is ranked higher than every other ingress link in each outage event. However, those candidate ingress links to which data traffic does not shift are not ranked against one another. The ingress links of different outage events are also not ranked against one another. This ranking is then transformed into a labeled training data by compiling a list of “pairwise training data.” These labels are just there to force the machine learning model to produce desired rankings. In other words, some implementations of the described technology use labels here as a mathematical constraint to force the machine learner to produce our desired rankings.

In some implementations, the SVM employs a hinge loss function, although other loss functions may be employed. Indeed, other machine learning models, such as deep neural networks or decision trees, and these models may use different loss functions.

The prediction scores 314 yield a ranked list 316 of candidate ingress links from the candidate ingress link most likely to receive the shifted data traffic (e.g., corresponding to the higher prediction scores) to the candidate ingress link least likely to receive the shifted data traffic (e.g., corresponding to the lower predictions scores). The ranked list 316 is output through the communication interface 302, such as for use by network management resources to evaluate and/or adjust network resources in the communication network.

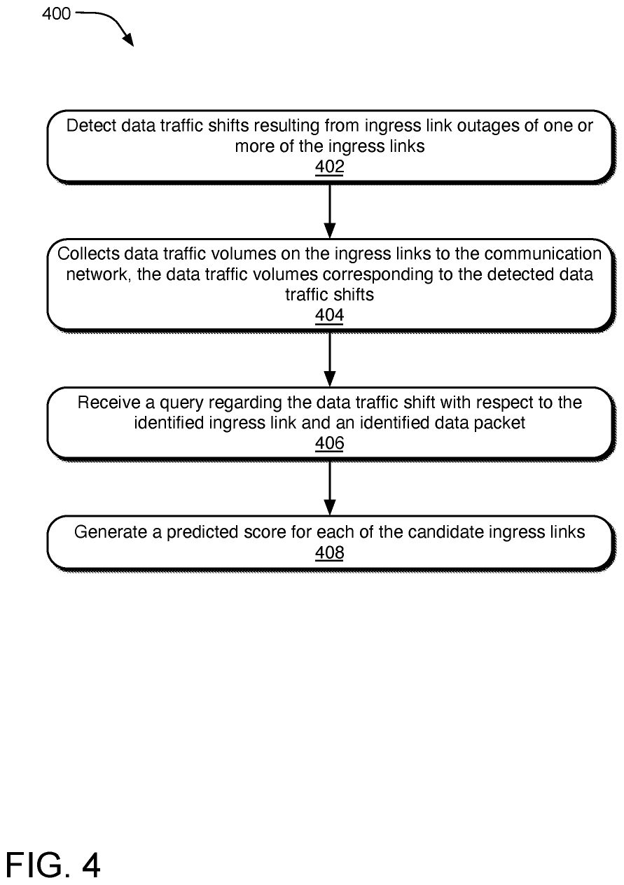

FIG. 4 illustrates example operations 400 for predicting a data traffic shift responsive to an outage of an identified ingress link to a communication network having ingress links including the identified ingress link and candidate ingress links. A detection operation 402 detects data traffic shifts resulting from ingress link outages of one or more of the ingress links. A collecting operation 404 collects data traffic volumes on the ingress links to the communication network. The data traffic volumes correspond to the detected data traffic shifts and ingress link outages. A receiving operation 406 receives a query regarding the data traffic shift with respect to the identified ingress link and an identified data packet.

A generating operation 408 generates, responsive to the query, a predicted score for each of the candidate ingress links. Each predicted score indicates a likelihood that data traffic corresponding to the identified data packet will shift from the identified ingress link to a corresponding one of the candidate ingress links responsive to the outage of the identified ingress link and is generated by a shift prediction machine learning model trained by the collected data traffic volumes corresponding to the detected data traffic shifts. A ranking operation 410 ranks the candidate ingress links according to the predicted score of each candidate ingress link to yield a ranked list of the candidate ingress links to which the data traffic can shift. The candidate ingress links are ranked according to the predicted score of each candidate ingress link to yield a ranked list of the candidate ingress links to which the data traffic can shift.

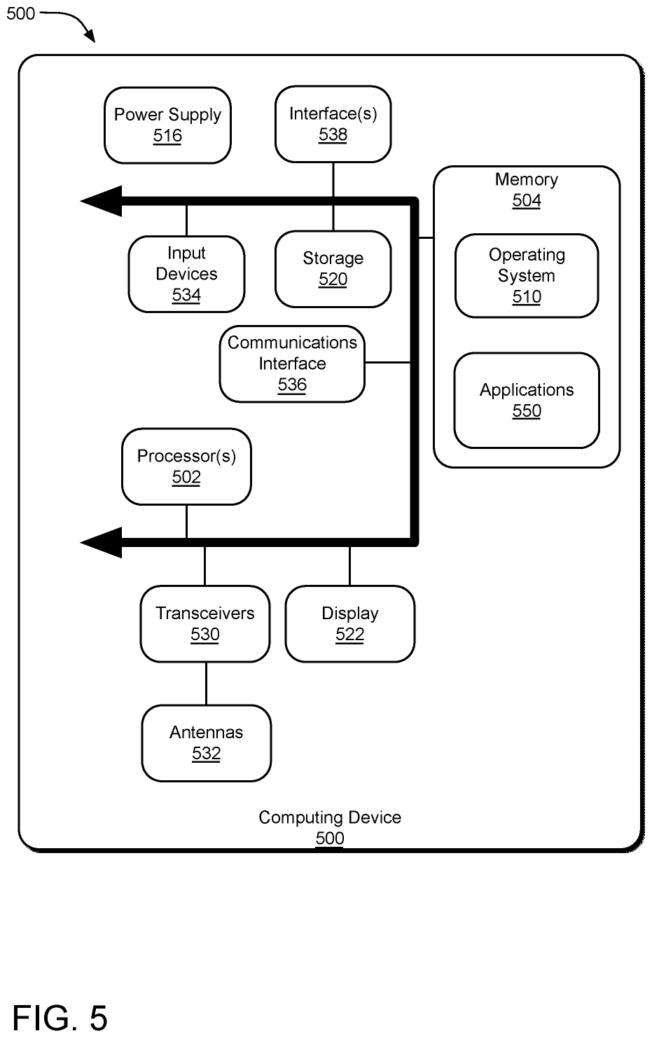

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as applications 550, a data traffic shift detector, a data traffic collector, a shift prediction machine learning model, a ranker, and other program code and modules are loaded into the operating system 510 on the memory 504 and/or the storage 520 and executed by the processor(s) 502. The storage 520 may store a data traffic characteristics, ranked lists, prediction scores, training data, and other data and be local to the computing device 500 or may be remote and communicatively connected to the computing device 500. In particular, in one implementation, components of a system for predicting a data traffic shift responsive to an outage of an identified ingress link to a communication network may be implemented entirely in hardware or in a combination of hardware circuitry and software.

The computing device 500 includes a power supply 516, which may include or be connected to one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any non-transitory storage media that can be accessed by the computing device 500 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture, which excludes software per se. An article of manufacture may comprise a tangible, non-transitory storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

Clause 1. A method of predicting a data traffic shift responsive to an outage of an identified ingress link to a communication network having ingress links including the identified ingress link and candidate ingress links, the method comprising: detecting data traffic shifts resulting from ingress link outages of one or more of the ingress links; collecting data traffic volumes on the ingress links to the communication network, the data traffic volumes corresponding to the detected data traffic shifts; receiving a query regarding the data traffic shift with respect to the identified ingress link and an identified data packet; and generating, responsive to the query, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

Clause 2. The method of clause 1, wherein the candidate ingress links are ranked according to the predicted score of each candidate ingress link to yield a ranked list of the candidate ingress links to which the data traffic can shift.

Clause 3. The method of clause 1, wherein training of the shift prediction machine learning model is based on at least a feature representing the collected data traffic volumes of the data traffic traversing through each of the candidate ingress links from a same source autonomous system or source internet protocol prefix as the identified data packet.

Clause 4. The method of clause 1, wherein training of the shift prediction machine learning model is based on at least a feature representing including the collected data traffic volumes of the data traffic traversing through each of the candidate ingress links from a same source autonomous system as the identified data packet and from any other source autonomous system that communicated data traffic through the identified ingress link.

Clause 5. The method of clause 1, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source autonomous system as the identified data packet.

Clause 6. The method of clause 1, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link and through a same source autonomous system.

Clause 7. The method of clause 1, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link.

Clause 8. The method of clause 1, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source internet protocol prefix as the identified data packet.

Clause 9. The method of clause 1, wherein training of the shift prediction machine learning model is based on at least a feature representing a geographic distance of a connection of the identified ingress link to the communication network and connections of the candidate ingress links to the communication network.

Clause 10. The method of clause 1, wherein training of the shift prediction machine learning model is based on a feature identifying whether the identified ingress link and the candidate ingress links are connected to at least one identical autonomous system.

Clause 11. A computing system for predicting a data traffic shift responsive to an outage of an identified ingress link to a communication network having ingress links including the identified ingress link and candidate ingress links, the computing system comprising: one or more hardware processors; a data shift detector executable by the one or more hardware processors and configured to detect data traffic shifts resulting from ingress link outages of one or more of the ingress links; a data traffic collector executable by the one or more hardware processors and configured to collect data traffic volumes on the ingress links to the communication network, the data traffic volumes corresponding to the detected data traffic shifts; and a shift prediction machine learning model executable by the one or more hardware processors, trained by the collected data traffic volumes, and configured to generate, responsive to a received query regarding the data traffic shift with respect to the identified ingress link and an identified data packet, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by the shift prediction machine learning model trained by the collected data traffic volumes corresponding to the detected data traffic shifts, wherein the candidate ingress links are ranked according to the predicted score of each candidate ingress link to yield a ranked list of the candidate ingress links to which the data traffic can shift.

Clause 12. The computing system of clause 11, wherein training of the shift prediction machine learning model is based on at least a feature representing the collected data traffic volumes of the data traffic traversing through each of the candidate ingress links from a same source autonomous system or source internet protocol prefix as the identified data packet.

Clause 13. The computing system of clause 11, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source autonomous system as the identified data packet.

Clause 14. The computing system of clause 11, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source internet protocol prefix as the identified data packet.

Clause 15. One or more tangible processor-readable storage media embodied with instructions for executing on one or more processors and circuits of a computing device a process for predicting a data traffic shift responsive to an outage of an identified ingress link to a communication network having ingress links including the identified ingress link and candidate ingress links, the process comprising: detecting data traffic shifts resulting from ingress link outages of one or more of the ingress links; collecting data traffic volumes on the ingress links to the communication network, the data traffic volumes corresponding to the detected data traffic shifts; receiving a query regarding the data traffic shift with respect to the identified ingress link and an identified data packet; and generating, responsive to the query and by a ranking support vector machine model, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

Clause 16. The one or more tangible processor-readable storage media of clause 15, wherein training of the shift prediction machine learning model is based on at least a feature representing the collected data traffic volumes of the data traffic traversing through each of the candidate ingress links from a same source autonomous system or internet protocol prefix as the identified data packet.

Clause 17. The one or more tangible processor-readable storage media of clause 15, wherein training of the shift prediction machine learning model is based on at least a feature representing including the collected data traffic volumes of the data traffic traversing through each of the candidate ingress links from a same source autonomous system as the identified data packet and from any other source autonomous system that communicated data traffic through the identified ingress link.

Clause 18. The one or more tangible processor-readable storage media of clause 15, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link and through a same source autonomous system.

Clause 19. The one or more tangible processor-readable storage media of clause 15, wherein training of the shift prediction machine learning model is based on at least a feature representing a geographic distance of a connection of the identified ingress link to the communication network and connections of the candidate ingress links to the communication network.

Clause 20. The one or more tangible processor-readable storage media of clause 15, wherein training of the shift prediction machine learning model is based on a feature identifying whether the identified ingress link and the candidate ingress links are connected to at least one identical autonomous system.

Clause 21. A system of predicting a data traffic shift responsive to an outage of an identified ingress link to a communication network having ingress links including the identified ingress link and candidate ingress links, the method comprising: means for detecting data traffic shifts resulting from ingress link outages of one or more of the ingress links; means for collecting data traffic volumes on the ingress links to the communication network, the data traffic volumes corresponding to the detected data traffic shifts; means for receiving a query regarding the data traffic shift with respect to the identified ingress link and an identified data packet; and generating, responsive to the query, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

Clause 22. The system of clause 21, wherein the candidate ingress links are ranked according to the predicted score of each candidate ingress link to yield a ranked list of the candidate ingress links to which the data traffic can shift.

Clause 23. The system of clause 21, wherein training of the shift prediction machine learning model is based on at least a feature representing the collected data traffic volumes of the data traffic traversing through each of the candidate ingress links from a same source autonomous system or source internet protocol prefix as the identified data packet.

Clause 24. The system of clause 21, wherein training of the shift prediction machine learning model is based on at least a feature representing including the collected data traffic volumes of the data traffic traversing through each of the candidate ingress links from a same source autonomous system as the identified data packet and from any other source autonomous system that communicated data traffic through the identified ingress link.

Clause 25. The system of clause 21, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source autonomous system as the identified data packet.

Clause 26. The system of clause 21, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link and through a same source autonomous system.

Clause 27. The system of clause 21, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link.

Clause 28. The system of clause 21, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source internet protocol prefix as the identified data packet.

Clause 29. The system of clause 21, wherein training of the shift prediction machine learning model is based on at least a feature representing a geographic distance of a connection of the identified ingress link to the communication network and connections of the candidate ingress links to the communication network.

Clause 30. The system of clause 21, wherein training of the shift prediction machine learning model is based on a feature identifying whether the identified ingress link and the candidate ingress links are connected to at least one identical autonomous system.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of predicting a data traffic shift responsive to an outage of an identified ingress link to a communication network having ingress links including the identified ingress link and candidate ingress links, the method comprising:
detecting data traffic shifts resulting from ingress link outages of one or more of the ingress links;
collecting data traffic volumes on the ingress links to the communication network, the data traffic volumes corresponding to the detected data traffic shifts;
receiving a query regarding the data traffic shift with respect to the identified ingress link and an identified data packet; and
generating, responsive to the query, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

2. The method of claim 1, wherein the candidate ingress links are ranked according to the predicted score of each candidate ingress link to yield a ranked list of the candidate ingress links to which the data traffic can shift.

3. The method of claim 1, wherein training of the shift prediction machine learning model is based on at least a feature representing the collected data traffic volumes of the data traffic traversing through each of the candidate ingress links from a same source autonomous system or source internet protocol prefix as the identified data packet.

4. The method of claim 1, wherein training of the shift prediction machine learning model is based on at least a feature representing including the collected data traffic volumes of the data traffic traversing through each of the candidate ingress links from a same source autonomous system as the identified data packet and from any other source autonomous system that communicated data traffic through the identified ingress link.

5. The method of claim 1, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source autonomous system as the identified data packet.

6. The method of claim 1, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link and through a same source autonomous system.

7. The method of claim 1, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link.

8. The method of claim 1, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source internet protocol prefix as the identified data packet.

9. The method of claim 1, wherein training of the shift prediction machine learning model is based on at least a feature representing a geographic distance of a connection of the identified ingress link to the communication network and connections of the candidate ingress links to the communication network.

10. The method of claim 1, wherein training of the shift prediction machine learning model is based on a feature identifying whether the identified ingress link and the candidate ingress links are connected to at least one identical autonomous system.

11. A computing system for predicting a data traffic shift responsive to an outage of an identified ingress link to a communication network having ingress links including the identified ingress link and candidate ingress links, the computing system comprising:
one or more hardware processors;
a data shift detector executable by the one or more hardware processors and configured to detect data traffic shifts resulting from ingress link outages of one or more of the ingress links;
a data traffic collector executable by the one or more hardware processors and configured to collect data traffic volumes on the ingress links to the communication network, the data traffic volumes corresponding to the detected data traffic shifts; and
a shift prediction machine learning model executable by the one or more hardware processors, trained by the collected data traffic volumes, and configured to generate, responsive to a received query regarding the data traffic shift with respect to the identified ingress link and an identified data packet, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by the shift prediction machine learning model trained by the collected data traffic volumes corresponding to the detected data traffic shifts, wherein the candidate ingress links are ranked according to the predicted score of each candidate ingress link to yield a ranked list of the candidate ingress links to which the data traffic can shift.

12. The computing system of claim 11, wherein training of the shift prediction machine learning model is based on at least a feature representing the collected data traffic volumes of the data traffic traversing through each of the candidate ingress links from a same source autonomous system or source internet protocol prefix as the identified data packet.

13. The computing system of claim 11, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source autonomous system as the identified data packet.

14. The computing system of claim 11, wherein training of the shift prediction machine learning model is based on at least a feature representing cosine similarities between the collected data traffic volumes of data traffic traversing through the identified ingress link and the collected data traffic volumes of data traffic traversing through each of the candidate ingress links to the communication network from a same source internet protocol prefix as the identified data packet.

15. One or more tangible processor-readable storage media embodied with instructions for executing on one or more processors and circuits of a computing device a process for predicting a data traffic shift responsive to an outage of an identified ingress link to a communication network having ingress links including the identified ingress link and candidate ingress links, the process comprising:
detecting data traffic shifts resulting from ingress link outages of one or more of the ingress links;
collecting data traffic volumes on the ingress links to the communication network, the data traffic volumes corresponding to the detected data traffic shifts;
receiving a query regarding the data traffic shift with respect to the identified ingress link and an identified data packet; and
generating, responsive to the query and by a ranking support vector machine model, a predicted score for each of the candidate ingress links, wherein each predicted score indicates a likelihood that data traffic corresponding to the identified data packet will shift from the identified ingress link to a corresponding one of the candidate ingress links responsive to the outage of the identified ingress link, and each predicted score is generated by a shift prediction machine learning model trained by the collected data traffic volumes corresponding to the detected data traffic shifts.

16. The one or more tangible processor-readable storage media of claim 15, wherein training of the shift prediction machine learning model is based on at least a feature representing the collected data traffic volumes of the data traffic traversing through each of the candidate ingress links from a same source autonomous system or internet protocol prefix as the identified data packet.

17. The one or more tangible processor-readable storage media of claim 15, wherein training of the shift prediction machine learning model is based on at least a feature representing including the collected data traffic volumes of the data traffic traversing through each of the candidate ingress links from a same source autonomous system as the identified data packet and from any other source autonomous system that communicated data traffic through the identified ingress link.

18. The one or more tangible processor-readable storage media of claim 15, wherein training of the shift prediction machine learning model is based on at least a feature representing the collected data traffic volumes of the data traffic traversing through each of the candidate ingress links from a same source internet protocol prefix as the identified data packet and from any other source internet protocol prefix that communicated data traffic through the identified ingress link and through a same source autonomous system.

19. The one or more tangible processor-readable storage media of claim 15, wherein training of the shift prediction machine learning model is based on at least a feature representing a geographic distance of a connection of the identified ingress link to the communication network and connections of the candidate ingress links to the communication network.

20. The one or more tangible processor-readable storage media of claim 15, wherein training of the shift prediction machine learning model is based on a feature identifying whether the identified ingress link and the candidate ingress links are connected to at least one identical autonomous system.
